(19) United States
(12) Patent Application Publication
(10) Pub. No.: US 2015/0091532 A1
(43) Pub. Date: Apr. 2, 2015

(54) METHOD OF CONTROLLING CHARGING OF A BATTERY

(71) Applicant: RENAULT s.a.s., Boulogne-Billancourt (FR)

(72) Inventors: Pedro Kvieska, Versailles (FR); Ludovic Merienne, Gif Sur Yvette (FR)

(73) Assignee: RENAULT s.a.s., Boulogne-Billancourt (FR)

(21) Appl. No.: 14/396,549

(22) PCT Filed: Apr. 19, 2013
(86) PCT No.: PCT/FR13/50869

§ 371 Date: Oct. 23, 2014

Related U.S. Application Data
(60) Provisional application No. 61/654,380, filed on Jun. 1, 2012.

(30) Foreign Application Priority Data
Apr. 27, 2012 (FR) 1253896

(51) Int. Cl. H02J 7/00; B60L 11/18

(52) U.S. Cl. CPC H02J 7/0052; H02J 7/007; B60L 11/1809; H02J 2007/0059
USPC 320/137

(57) ABSTRACT

A method of controlling charge of a battery, or of a battery of a motor vehicle, on the basis of a monophase network, in which: the input voltage is filtered; the electrical power of the network is conveyed to the battery via a voltage step-down stage and a voltage step-up stage which are coupled together via an inductive component; and an intensity of current passing through the inductive component is controlled as a function of an intensity setpoint, the intensity not being continuously controllable. The intensity setpoint is formulated to have at least a first value and at least a second value greater than the first value, the intensity setpoint having the second value before the start of a phase during which the intensity is not controllable.

The invention relates to a device for charging a high-voltage battery, particularly of an electric drive motor vehicle, from a monophase supply network.

In high-voltage battery recharging systems, the electrical power of the network is supplied to the battery successively through two converters: a buck and a boost. These two converters allow the voltage ratio between the output terminal thereof and the input terminal thereof to be lowered and raised, respectively, by opening and closing successively a series of switches, at a frequency which is controlled as a function of the output current, and/or of the desired output voltage.

Such recharging systems are, for example, described in patent application FR 2 943 188, which relates to a motor vehicle on-board recharging system, allowing recharging of a vehicle battery from a three-phase or monophase circuit. The recharging circuit incorporates the coils of an electric machine which, moreover, provides other functions such as the generation of current or the propulsion of the vehicle.

The chopping of the current drawn from the supply network produces high-frequency components in the drawn current, i.e. harmonics of an order greater than the fundamental of the distribution network which is conventionally 50 Hz.

Since the electricity distributor sets a standard on the harmonics of the drawn current, such a recharging system also includes an RLC (Resistive-Inductive-Capacitive) filter at the input of the buck. This filter causes a phase shift between the current and the voltage which are drawn from the network. This phase shift involves a reactive power passing through the network, but not drawn by the user, with an aim of also minimizing it.

Furthermore, domestic supply networks are mainly monophase supply networks. A vehicle comprising a device for recharging a battery from a monophase supply can, therefore, be recharged on a domestic supply network, for example, in the garage or parking space of an individual.

Recharging from a monophase supply network has some specific features.

Depending on the topology thereof, it is not possible to phase the input current with the voltage of the network. Moreover, when the input sinusoidal voltage is close to zero, the system becomes momentarily uncontrollable. Furthermore, for the power flow to be established continuously, a non-zero current must flow in the storage inductor of the electric machine between the buck and the boost. This then raises the problem of the value of the current passing through the inductor during the system uncontrollability phases. Indeed, during these phases, particularly the current passing through the inductor cannot be controlled.

One solution would be to use a storage high inductor such that the current in the inductor does not have the time to drop to a zero value. However, this solution has the disadvantage of a large volume of this inductor.

In view of the above, an aim of the invention is to propose a method for charging a battery which allows the aforementioned disadvantages to be resolved at least partially.

In particular, the objective of the invention is to propose a charging method for preventing the value of the current passing through the inductor of the electric machine from passing through zero.

An aim of the invention is also to increase the energy efficiency of the charging systems.

Another aim of the invention is to propose a charging method which does not require a high value inductor.

According to one aspect, a method of controlling charging of a battery, particularly a battery of a motor vehicle, from a monophase network is proposed, wherein:
the input voltage is filtered;
the electrical power of the network is supplied to the battery via a buck stage and a boost stage which are coupled together via an inductive component; and
an intensity passing through said inductive component is monitored as a function of an intensity setpoint, said intensity not being continuously controllable.

According to a general feature of this method, the intensity setpoint is worked out in such a way that said intensity setpoint has at least a first value and at least a second value greater than the first value, the intensity setpoint having the second value before the start of a phase during which the intensity is not controllable.

During the phases when the current is not controllable which are also called uncontrollability phases, the intensity passing through the inductive component can only decrease. Therefore, selecting a sufficiently high second setpoint value prevents the intensity passing through the inductive component from reaching the zero value which is to be avoided. Moreover, given that the setpoint takes the first value outside of the uncontrollability phases, the average value of the intensity passing through the inductive component is greatly decreased in relation, for example, to a constant setpoint taking the second value. The recharging energy efficiency is therefore improved.

According to an embodiment, the intensity setpoint is worked out such that said setpoint has a third value, which is less than the first two values, the setpoint moving from the second to the third value during a phase in which the intensity is not controllable.

Therefore, thanks to a setpoint taking a value less than the first two values, at the end of the uncontrollability phases the current passing through the inductive component is increased again from a lower value which reduces the average value of this current just as much.

According to an embodiment, the intensity setpoint is worked out such that, after having had the third value, the setpoint moves from the third to the first value by following an increasing affine function.

Therefore, during the resumption of controllability, the current which will follow the setpoint thereof starts from a value lower than the first two values in order to slowly reach the first value. Therefore, this prevents the current from increasing again too suddenly which can, indeed, produce harmonics on the current and/or cause the setpoint induction intensity to be exceeded.

According to another embodiment, the intensity setpoint is worked out such that, when moving from the second to the third value, the intensity setpoint takes a constant value for a specific duration.

The presence of this plateau during an uncontrollability phase allows the setpoint to be prevented from further decreasing the current passing through the inductive component.

According to a feature of this other embodiment, said constant value is equal to the first value.

According to another embodiment, an input current of the buck stage is created in phase with the input voltage of the buck stage.

This phase shift causes, indeed, a reactive power passing through the network but which is not drawn by the battery charging. Therefore, it is advantageous to be able to minimize this phase shift and reduce the reactive power. This phase shift is, for example, due to an RLC filter which causes a phase shift between the current and the voltage which are drawn from the network.

Preferably, the input current of the buck stage is regulated by controlling, in open loop, a chopping duty cycle of the buck stage as a function of the voltage of the monophase supply network, of a setpoint power and of the intensity of the current passing through the inductive component in order to phase the input current of the buck stage with the input voltage of the buck stage, and control the power received by the battery with respect to the setpoint power.

The intensity of the current passing through the battery can also be regulated with respect to a reference battery intensity by controlling, in closed loop, a chopping duty cycle of the boost stage as a function of the voltage at the output of the buck stage, of the voltage of the battery, and of the difference between the intensity setpoint and the intensity of the current passing through the inductive component.

Advantageously, the integral part of a proportional integral controller can be deactivated if the chopping duty cycle is equal, within one threshold distance, to values 0 or 1.

Other advantages and features of the invention will emerge upon examining the detailed description of an embodiment of the invention, which embodiment is in no way limiting, and the appended drawings wherein:

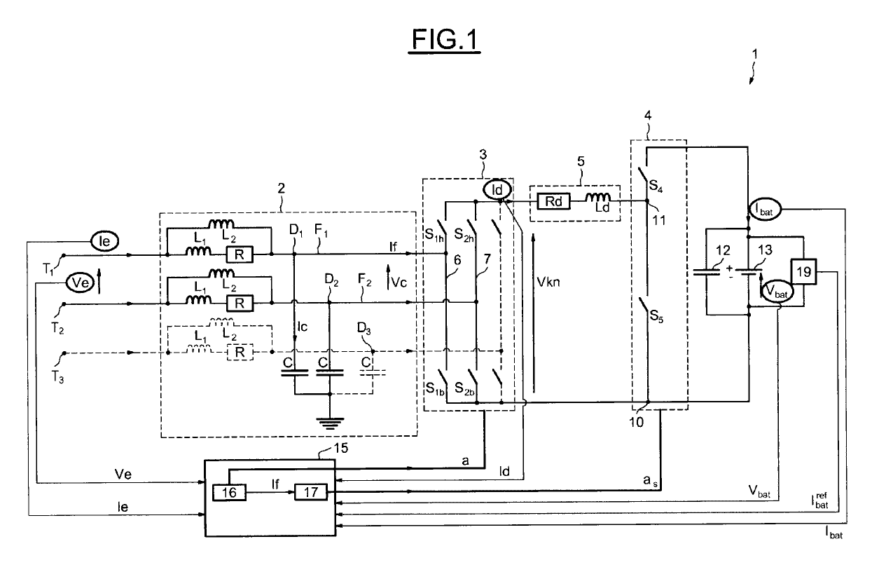

FIG. 1 illustrates a recharging device according to an embodiment of the invention;

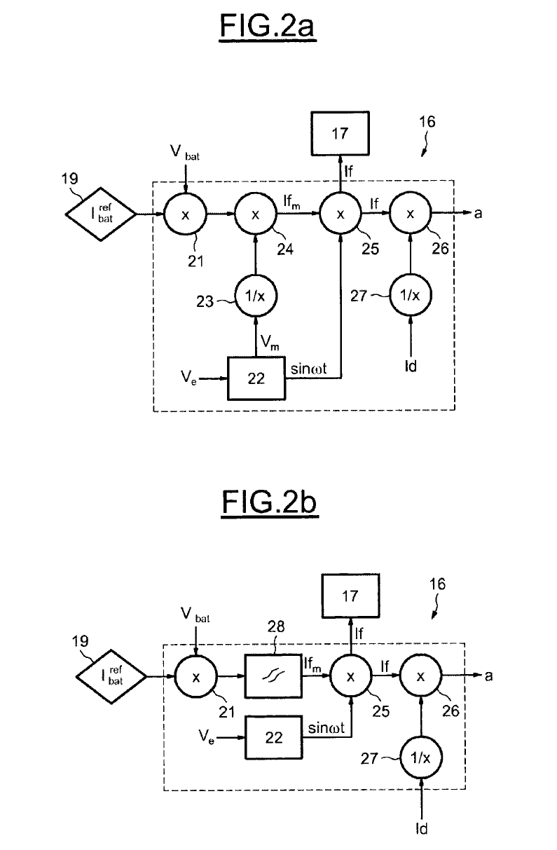

FIGS. 2a and 2b illustrate a first and a second embodiment of a first monitoring module, respectively;

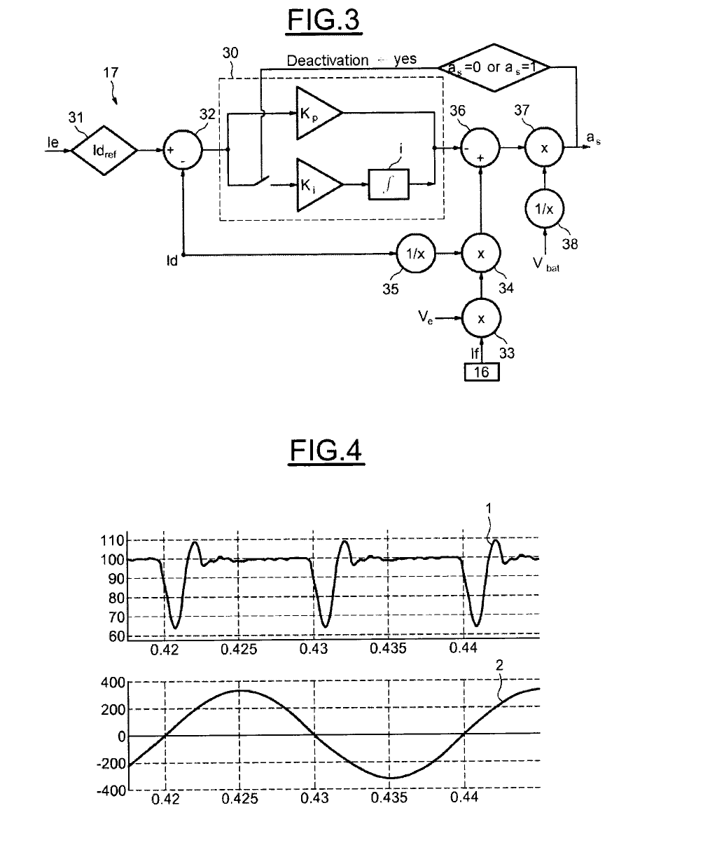

FIG. 3 schematically shows an embodiment of a second monitoring module;

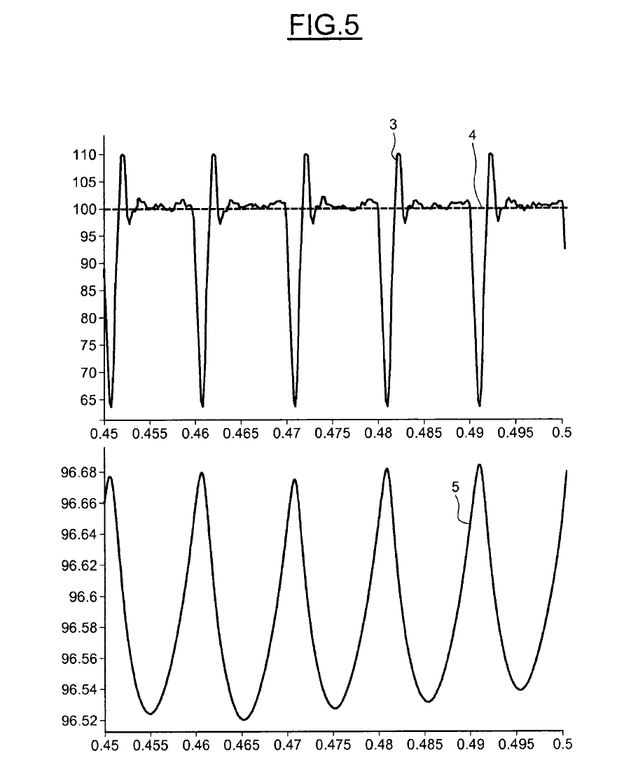

FIG. 4 shows a graph of the current passing through the induction coil;

FIGS. 5-8 show graphs of the current passing through the induction coil as a function of the setpoint induction intensity; and

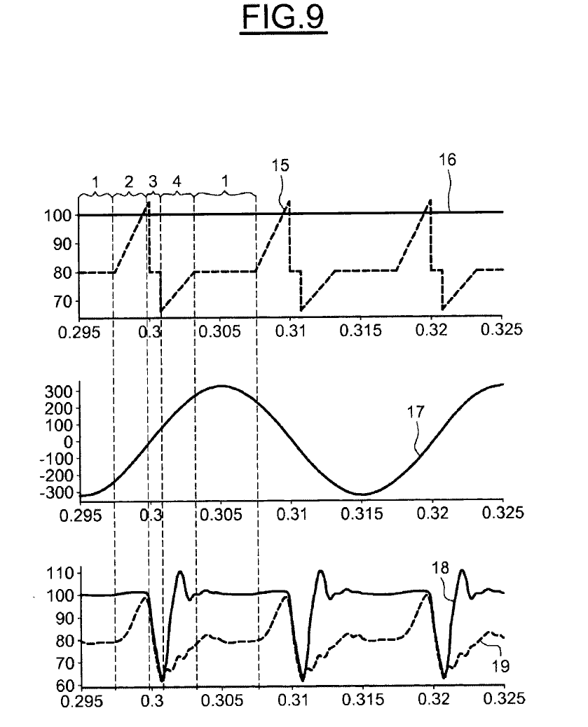

FIG. 9 illustrates the comparison of the variables of the recharging system as a function of the setpoint.

FIG. 1 schematically shows a device for charging a battery of an electric drive motor vehicle from a monophase supply network, according to an embodiment.

The recharging device 1 comprises a filtering stage 2, a buck stage 3 connected to the filtering stage 2, and a boost stage 4 connected to the buck stage 3 via an electric machine 5.

Since the device 1 can be connected to a three-phase and monophase supply, it comprises three terminals T₁, T₂, T₃ connected at the input of the filtering stage 2, and which can be connected to a supply network. For monophase recharging, only the inputs T₁ and T₂ are connected to a monophase supply network providing an input voltage Ve and an input current Ie.

Each input terminal T₁, T₂ and T₃ is connected to a filtering branch of the filtering stage 2. Each filtering branch comprises two parallel branches, one having an inductor of value L₂ and the other having, in series, an inductor of value L₁ and a resistor of value R.

These two filtering branches are each connected, at output, to a capacitor of capacitance C, at a point called D₁, D₂, D₃, respectively, for each of the filtering branches. All of the resistors of values R, the inductors of values L₁ or L₂, and the capacitors of capacitance C form an RLC filter at the input of the buck 3.

In the case of monophase recharging, the terminal T₃ is not connected to the supply network. Since the filtering branch connected to the terminal T₃ is not used, it will not be considered in the remainder of the description and has been shown in dotted line. The other elements of the electric circuit shown in dotted line are elements which are only used in the context of connection to a three-phase supply network.

The buck stage 3 is connected to the filtering stage 2 by points D₁ and D₂. The buck 3, operating with a monophase supply, comprises two parallel branches 6 and 7, each having two switches S₁ₕ and S_{1b} or S₂ₕ and S_{2b} which are controlled by a regulating unit 15.

Each input D₁ or D₂ of the buck is connected, via a branch F₁ and F₂ respectively, to a connection point located between two switches S₁ₕ and S_{1b} or S₂ₕ and S_{2b} of a same branch 6 and 7 respectively.

The shared ends of the branches 6 and 7 form two output terminals of the buck 3. One of the terminals is connected to the “−” terminal of the battery 13 and to a first input 10 of a boost 4. The other of these terminals is connected to a first terminal of an electric machine 5, the other terminal of which is connected to a second input 11 of the boost 4.

The boost 4 comprises two switches S₄ and S₅ independently controlled by the regulating unit 15. These two switches S₄ and S₅ are located on a branch connecting the first input 10 of the boost 4 and the “+” terminal of the battery 13. The second input 11 of the boost 4, to which is connected the electric machine 5, is connected between the two switches S₄ and S₅, the switch S₄ being connected between the second input 11 and the “+” terminal of the battery 143, and the switch S₅ being connected between the first input 10 and the second input 11.

An electric machine 5, deemed a resistor of value Rd placed in series with an inductance coil Ld, is connected between the output terminal of the buck 3 and the second input 11 of the boost 4. There is no departure from the scope of the invention if the electric machine 5 is replaced with a non-resistive inductance coil or if an additional induction coil is branched in series with the electric machine 5.

Connected to the terminals of the battery 13 is a capacitor 12 for keeping relatively stable the voltage at the terminals of the battery 13, and a module 19 for monitoring charge of the battery, which can provide a setpoint value I_{bat}^{ref} giving, as a function of the charge level of the battery, the current optimum intensity to be input via the “+” terminal of the battery 13. The charge monitoring module 19 transmits the setpoint value I_{bat}^{ref} to the regulating unit 15 via a dedicated connection.

Measuring means, which are optionally incorporated in the module 19, furthermore transmit to the regulating unit 15 a value I_{bat} giving a current measured intensity actually entering the battery, and a value V_{bat} giving the voltage between the “−” terminal and the “+” terminal of the battery 13.

Other current intensity measuring modules allow the measurement and the transmission to the regulating unit 15 of the value Id of current passing through the electric machine 5, the value Ie of current intensity of the supply network entering the filtering stage 2, and the value Ve of supply input voltage of the network.

The regulating unit 15 comprises a first monitoring module 16 for determining the chopping duty cycle a of the buck stage 3, and a second monitoring module 17 for determining a chopping duty cycle aₛ setpoint of the boost stage 4.

The regulating unit 15 comprises, for this purpose, two driver modules (not shown), for the first one to set an opening and closing temporal pattern for each of the switches of the buck 3, such as to obtain the chopping duty cycle a of the buck stage 3, and for the second one to set an opening and closing temporal pattern for each of the switches S₄ and S₅ of the boost 4, such as to obtain the duty cycle aₛ.

Preferably, the switches are transistors allowing rapid switching, for example IGBT (Insulated Gate Bipolar Transistor) transistors.

To assess the duty cycles a and aₛ the regulating unit 15 receives, at input, the values of the network supply voltage Ve, of the intensity Id of the current passing through the electric machine 5, of the voltage V_{bat} passing through the battery 13, the intensity I_{bat} of the current passing through the battery 13, and the reference battery intensity I_{bat}^{ref} provided by the charge monitoring module 19.

Depending on the duty cycle a, the regulating unit 15 controls the state of each of the switches S₁ₕ, S_{1b}, S₂ₕ and S_{2b} of the buck stage 3. Likewise, depending on the duty cycle aₛ, the regulating unit 15 can control the state of the switches S₄ and/or S₅ of the boost stage 4.

For information purposes only, the characteristic values of the electric elements of the charging device 1 are in the following value ranges:
the capacitors of the filter 2 represent a few hundred μF, for example between 100 and 500 μF each,
the capacitor 12 placed at the terminals of the battery 13 in order to stabilize the voltage of the terminals, is in the mF region, for example between 1 and 10 mF,
the resistors of values R of the filtering circuit 2 are in the ohm region, for example between 1 and 10 Ω,
the resistor Rd of the rotor of the electric machine Em is approximately a few dozen mΩ, for example between 0.01Ω and 0.1 Ω,
the inductors L₁, L₂, Ld, corresponding to the inductors of the filtering stage 2 and to the coil of the electric machine 5, respectively, have values of approximately a few dozen μH, for example values of between 10 μH and 100 μH.

The regulating unit works out, using the first monitoring module 16 and the second module 17, chopping duty cycle a, aₛ setpoint values for the buck 3 and for the boost 4, for meeting three objectives:
monitoring the amplitude of the input current If of the buck stage 3 and ensuring that this current If is in phase with the input voltage Ve (the aim of this monitoring is to create an input current If of the buck stage 3 in phase with the input voltage), which amounts to controlling the drawn power with respect to the supply network,
obtaining a measured current entering I_{bat} via the “+” terminal of the battery 13, corresponding to the supply requirements of the battery 13, these requirements being determined by the charge monitoring module 19 and delivered as function I_{bat}^{ref} to the regulating unit 15,
preventing cancellation of the current Id passing through the induction coil Ld of the electric machine 5.

Since the voltage decrease is negligible over the filtering stage 2 for the power range of use, it is not necessary to describe the equations of the input filter.

It is considered that the voltage Vc at the input of the buck stage 3 is equal to the input voltage Ve of the supply network.

The output voltage Vkn of the buck stage 3 is equal to a·Ve. Being equal to a·Ve, this can give the equation of the branch bearing the electric machine 5 as:

Rd·Id+Ld·s·Id=a·Ve−aₛ·V_{bat} (equation 1)

where s is the Laplace variable,

a is the chopping duty cycle of the buck stage 3, and aₛ is the duty cycle of the boost stage 4.

The chopping duty cycle a of the buck stage 3 can also be written a=If/Id, wherein If is the input current in the boost stage 3, and the chopping duty cycle aₛ of the boost stage 4 is given as aₛ=I_{bat}/Id.

The equation (1) can, therefore, also be written as:

$$\begin{matrix}Rd \cdot Id + Ld \cdot s \cdot Id = ( If \cdot Ve - {I}_{bat} \cdot {V}_{bat} ) / Id \\ or \text{:} & ( equation 2 ) \\ Rd \cdot {Id}^{2} + \frac{Ld}{2} \cdot s \cdot {Id}^{2} = If \cdot Ve - {I}_{bat} \cdot {V}_{bat} & ( equation 3 )\end{matrix}$$

According to equation 3, the intensity If of the input current of the buck stage 3 can therefore be used as a control variable in order to control the current Id passing through the electric machine 5 with respect to a setpoint value Id^{ref} which will be worked out such as to prevent the cancellation of the current in the inductance coil Ld.

When the input voltage Ve is close to zero, the system, even if it is a controlled system, becomes uncontrollable. According to the equations, during these phases of uncontrollability, the current Id in the coil Ld of the electric machine 5 can only decrease, as is illustrated in FIG. 4.

Dividing the value of the intensity If of the input current of the buck stage 3 by the value of the intensity Id of the current measured through the electric machine 5 by definition gives the value of the chopping duty cycle a of the buck stage 3.

The input voltage Vc of the buck stage 3, which is equal to the input voltage Ve of the supply network, is given as Vc=Ve=Vₘ sin(ωt).

Control ensures that If is in phase with the input voltage. The input current Ie is given by Ie=If+Ic, i.e.

Ie=Ifₘ sin(cot)+C/2 Vₘ cos(ωt).

The current If is, therefore, an image of the active power taken from the network. The latter is given by the relation P_{active}=Ifₘ Vₘ/2, where Ifₘ=2 P_{active}/Vₘ.

If the input current Ie is regulated by the input current If of the buck stage 3 and the current Id passing through the electric machine 5 is regulated by the input current If of the buck stage 3 in order to prevent the cancellation of current in the coil Ld of the electric machine 5, then the third objective of the regulation carried out by the regulating unit 15, relating to the control of the current entering the battery I_{bat} with respect to the setpoint value I_{bat}^{ref} delivered by the charge monitoring module 19, still needs to be met.

To this end, a chopping duty cycle aₛ can, for example, be set for the boost such as to respect the relation aₛ=I_{bat}^{ref}/Id.

The relation expressing the dynamics of the current through the electric machine 5, given by the equation (1) directly links the duty cycle aₛ of the boost stage 4 and the current Id passing through the electric machine 5.

It is therefore possible to control aₛ directly from the error between a reference value Id^{ref} and the measured value Id passing through the electric machine 5.

FIG. 2a schematically shows a first embodiment of the first monitoring module 16. The first monitoring module comprises open loop regulation of the input current If of the buck stage 3. The input current If of the buck stage 3 is regulated by calculating the chopping duty cycle a of the buck 3.

The chopping duty cycle a of the buck stage 3 is determined as a function of the setpoint power P_{bat}^{ref}, determined from the voltage of the battery V_{bat} and from the setpoint battery intensity I_{bat}^{ref}, from the input voltage Ve of the monophase supply network and from the intensity Id of the current passing through the induction coil Ld.

The first monitoring module 16 receives, on a first input, the battery intensity setpoint I_{bat}^{ref} and, on a second input, the voltage measured at the terminals of the battery V_{bat}. The setpoint intensity of the battery I_{bat}^{ref} and the voltage V_{bat} of the battery are delivered at the input of a first multiplier 21 which then outputs the setpoint power P_{bat}^{ref}.

On a third input, the monitoring module 16 receives the input voltage Ve of the supply network. The module 16 comprises a signal analyzer 22 for extracting the signal of normalized amplitude Vₘ, which signal is proportional to the input voltage Ve of the monophase supply network. The signal of amplitude Vₘ is delivered to a first inverter 23 which outputs the inverse of the amplitude Vₘ. The inverse Vₘ of this amplitude is delivered to a second multiplier 24 which receives, also in input, the setpoint power P_{bat}^{ref}.

The second multiplier 24 then outputs the amplitude Ifₘ of the input current of the buck stage 3 to a third multiplier 25 which also receives, in input, the phase signal sin(wt) of the input voltage Ve of the monophase supply network.

The third multiplier 25 then outputs the input current If of the buck stage 3 both to the second monitoring module 17 and to a fourth multiplier 26. The module 16 receives, on a fourth input, the value Id of the intensity of the current passing through the coil Ld of the electric machine 5. The value Id of the current passing through the coil Ld is delivered to a second inverter 27 which outputs the inverse of the intensity Id of the current passing through the coil Ld to the fourth multiplier 26.

The fourth multiplier 26 then carries out the calculation If/Id and outputs the value of the chopping duty cycle a of the buck stage 3, for controlling the input current If of the buck stage 3.

FIG. 2b illustrates a second embodiment of the first monitoring module 16.

In this module 16, the second multiplier 24 has been replaced by a mapping 28 delivering the amplitude Ifₘ of the input current If of the buck stage 3 as a function of the amplitude Vₘ of the input voltage Ve and of the setpoint power P_{bat}^{ref}.

FIG. 3 illustrates an embodiment of the second monitoring module 17.

In the charging device 1, the regulation of the current I_{bat} crossing into the battery 13 is controlled by the boost stage 4. Indeed, the current I_{bat} of the battery is given by the relation I_{bat}=aₛId.

Therefore, to control the current I_{bat} in the battery 13 with respect to the reference value thereof, the relation aₛ=I_{bat}^{ref}/Id is sufficient.

It is also possible to add a correction loop if the battery current measurement is available. In this case, the result is:

$${a}_{s} = \frac{1}{Id} \cdot [ {I}_{bat}^{ref} + α \cdot ( {I}_{bat}^{ref} - {I}_{bat} ) ] \qquad ( equation 4 )$$

where α is an adjustment parameter.

The second monitoring module 17 comprises closed loop regulation of the intensity Id of the current passing through the induction coil Ld of the electric machine 5.

The second monitoring module 17 receives, at a first input, a value Ie of the input intensity of the supply network. This intensity value Ie is delivered to a module 31 determining the value of the setpoint induction intensity Id^{ref}. The second monitoring module 17 receives, at a second input, the value Id of the intensity passing through the coil Ld of the electric machine 5. The value Id of the intensity is delivered to a negative input of a first subtracter 32 which receives, at a positive input, the value Id^{ref} of the setpoint induction intensity.

The first subtracter 32 then outputs the difference between the intensity Id of the current passing through the inductance coil Ld and the setpoint inductance intensity Id^{ref} to a proportional integral controller 30.

The proportional integral controller 30 comprises two parallel branches, a first of which includes a proportional control module Kₚ and a second of which includes an integral control module Kᵢ and an integration module i.

The second monitoring module 17 receives, on a third input, the value If of the intensity of the current at the input of the buck stage 3, which is delivered by the first monitoring module 16. The intensity If is delivered to a first multiplier 33, which receives, also in input, the input voltage Ve of the monophase network received on a fourth input of the second monitoring module 17.

The first multiplier 33 therefore outputs a value P_{active} of the active power. This value P_{active} is input to a second multiplier 34 which receives, also in input, the inverse of the current Id, the current Id having been delivered to a first inverter 35 beforehand.

The second multiplier 34 carries out the calculation P_{active}/Id and outputs a value Vkn of the output voltage of the buck stage 3. The voltage Vkn of the buck stage 3 is delivered to a positive input of a second subtracter 36 which receives on a negative input the output of the proportional integral controller 30.

The second subtracter 36 then outputs the addition of the difference between the intensity Id of the current passing through the inductance coil Ld and the setpoint inductance intensity Id^{ref} corrected by the proportional integral controller 30, and the output voltage Vkn of the buck stage 3 at the input of a third multiplier 37. The third multiplier 37 receives, also in input, the inverse of the battery voltage V_{bat}, the battery voltage V_{bat} having been received on a fifth input of the second monitoring module 17 and delivered beforehand to a second inverter 38.

The third multiplier 37 then outputs the setpoint value of the chopping duty cycle aₛ of the boost stage 4.

The second monitoring module 17 also comprises a feedback loop between the output of the third multiplier 37 and the input of the branch of the proportional integral controller 30 comprising the integral control module Kᵢ.

If the value of the chopping duty cycle aₛ of the boost stage 4 is equal to 0 or 1 within one threshold, the integral control branch is deactivated.

This feedback loop corresponds to an anti-runaway technique used to overcome the uncontrollability of the device when the input voltage Ve is close to zero. Indeed, during the phases of uncontrollability, the control is saturated, i.e. the duty cycles of the switches, or IGBT transistors, are at 1, while it is not capable of reducing the difference. The feedback loop is used to prevent the continued inclusion of this error. Thus, once the device is controllable, the current Id passing through the coil Ld of the electric machine 5 is brought back to the reference value Id^{ref}.

The use of this feedback loop also allows a system to be controlled which has a coil Ld having extremely low inductance. The use of a low-inductance coil allows the volume of the charger to be reduced.

The invention allows an on-board charging device for a motor vehicle to be provided, which is suitable to be connected to an external monophase supply network, incorporating, in the circuit thereof, the coil of an electric machine of the vehicle, and allows the buck and the boost to be regulated such as to maintain a reduced phase shift between the current and the voltage which are drawn from the monophase supply network.

FIG. 4 illustrates two points of reference each comprising a horizontal axis showing the time in seconds and a vertical axis showing the current in amps and the voltage in volts, respectively. The illustrated curves 1 and 2 show the variation in the current Id in amps passing through the inductive component Ld for a setpoint or setpoint induction intensity of constant value, for example Id^{ref}=100 A, and the variation in the voltage Ve, as a function of the uncontrollability phases, respectively.

In FIG. 4, it appears that when the absolute value of the voltage Ve is close to the zero value, there is a phase of uncontrollability according to which the current Id falls rapidly. The phases of uncontrollability are, in the case of a periodic monophase input voltage, periodic with a frequency that is twice as much as that of the input voltage Ve.

Therefore, the phases of uncontrollability can be predicted and/or detected. For example, a threshold can be defined for the absolute value of the input voltage Ve below which a phase of uncontrollability is detected. According to another example, after the detection of a first phase of uncontrollability, the next phase can be predicted since they occur periodically.

FIG. 5 illustrates two points of reference each comprising a horizontal axis showing the time in seconds and a vertical axis showing the current in amps. The illustrated curves 3 and 4 show the detailed variation in the current Id in amps which passes through the inductive component Ld and the setpoint of constant value Id^{ref}=100 A delivered by the module 31 of FIG. 3, respectively. The illustrated curve 5 shows the variation in the value of the current Id after a running mean. It appears that, with a setpoint Id^{ref}=100 A, the current Id has an average value around 96.6 A, ranging between 96.52 and 96.68 A.

It is then envisaged to transmit, using the boost stage 4 (FIG. 1), the current Id to the battery in the form of the current I_{bat}. Yet, with a charging system such as that illustrated above, to charge a battery of 300 V with a power of 7 kW, the current I_{bat} must be 25 A. In a conventional European network of 230 Volts RMS, the network current drawn at such a power will be 30.5 A RMS, i.e. 43 A amplitude. It therefore appears that the Id average value (96.6 A) is large and also extremely different from the value of the current drawn by the battery I_{bat} and the drawn network current (43 A amplitude). This value that is large and different from the current I_{bat} and the network current involves energy losses as explained hereafter. One solution could be to lower the setpoint value Id^{ref} delivered by the module 31 of FIG. 3 in order to reduce the current Id.

This solution is not, in fact, possible since a non-zero current must always flow in the storage inductor of the electric machine between the buck and the boost, i.e. the current Id must always be greater than 0 A including during the uncontrollability phases. With a charging system as illustrated above and an amplitude of the input current Ie of approximately 43 A, a setpoint Id^{ref} involving a minimum value of the intensity Id of 55 A (this minimum value being reached, for example, during a controllability phase) only allows a safety margin of 12 A.

The use, as illustrated in FIG. 5, of a constant setpoint Id^{ref}=100 A allows a sufficient safety margin of approximately 20 A (this margin value is obtained by subtracting from minimum value during the uncontrollability phases of 63.79 A, the value of the amplitude of the input current 43 A: 63.79 A−43 A=20.79 A) but with an energy efficiency that is unsatisfactory due to the size of the current Id and the difference thereof with the current value drawn by the battery I_{bat}.

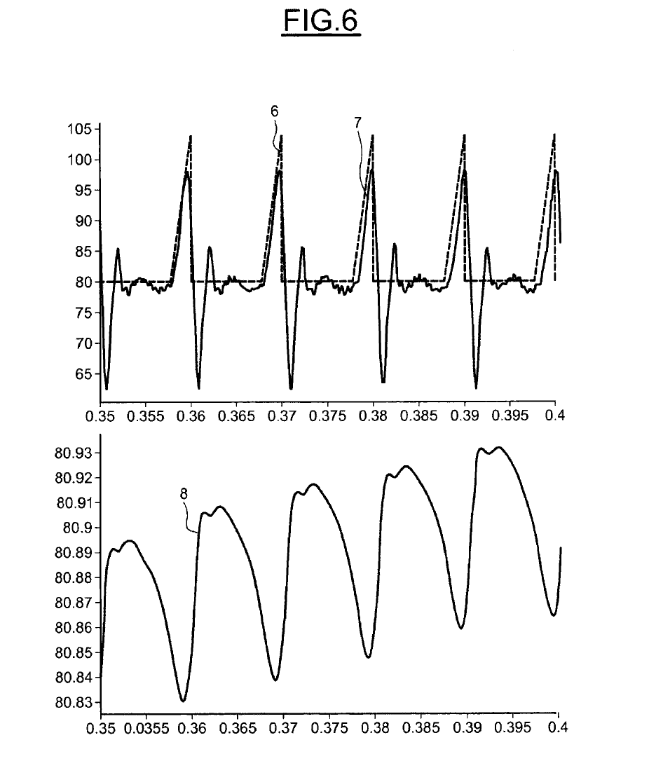

A solution to this problem is illustrated in FIG. 6. FIG. 6 illustrates two points of reference each comprising a horizontal axis showing the time in seconds and a vertical axis showing the current in amps. The illustrated curves 6 and 7 show a new setpoint Id^{ref} and the detailed variation in the current Id in amps passing through the inductive component as a function of this new setpoint, respectively.

According to the curve 6, it appears that the new setpoint takes two values, a first value equal to a mid-threshold of approximately 80 A and a second value equal to a high threshold of approximately 105 A. The setpoint increases rapidly from the first to the second value then, when it reaches the second value, it decreases instantly to the first value. The duration of increase from the first to the second value is, for example, π/4 radians, the reference being the electrical angle wt of the voltage Ve=Vₘ sin(ωt). The corresponding increase duration given in period is therefore ⅛ period, i.e. in the case of a frequency of 50 Hz: (π/4)/(2.π.50)=2.5 ms.

According to the curve 7, it appears that, with the setpoint Id^{ref} illustrated on the curve 6, the current Id takes a minimum value of approximately 62.71 A during the uncontrollability phases. This value is almost identical to that obtained with the constant setpoint fixed at Id^{ref}=100 A. This is the result of the setpoint taking the second value (105 A) just before the uncontrollability phase.

Moreover, the illustrated curve 8 shows the variation in the value of the current Id (curve 7) after a running mean. It appears that, with this new setpoint Id^{ref} (curve 6), the current Id has an average value around 80.9 A, ranging between 80.83 and 80.93 A.

Therefore, the new setpoint gives a current Id, the average value of which is greatly reduced but the minimum value of which is identical. FIG. 6 therefore illustrates a solution consisting of a new setpoint Id^{ref} taking two values as a result of which the average intensity of the current Id is reduced while allowing a minimum intensity of the current Id corresponding to an identical safety margin. Therefore, this gives an improved energy efficiency while retaining a sufficient safety margin. More precisely, the average current falls by 16% (80.9 A compared to 96.6 A), which allows not only a reduction of the ohmic losses and of the core losses in the electric machine 5 (FIG. 1) and but also switching of the boost stage 4 (FIG. 1) according to a duty cycle aₛ which allows a greater efficiency since the intensity Id is closer to I_{bat} while remaining greater than the latter.

Of course, it would also be possible, using other adjustments consisting, for example, of a setpoint, the high threshold value of which is increased, to obtain an increase in the energy efficiency and in the safety margin or an increase in the safety margin without increase in the energy efficiency.

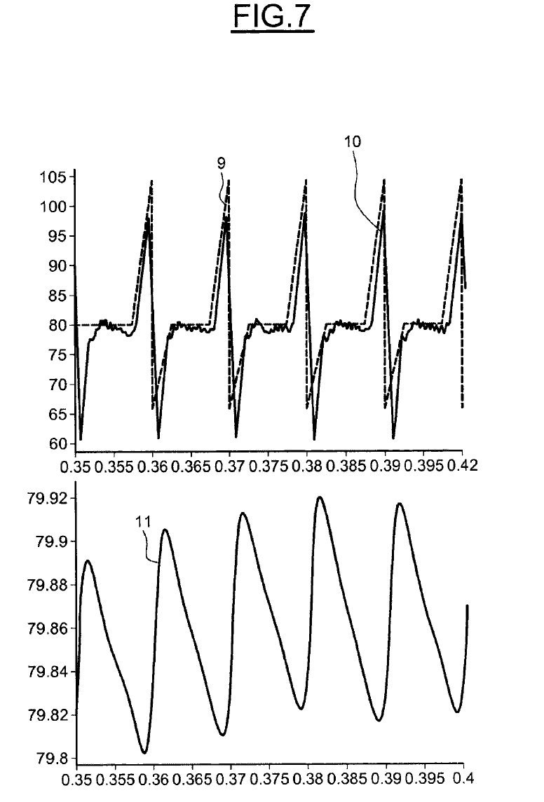

However, it appears in FIG. 6 that the curve 7 largely exceeds the setpoint during the resumption of controllability. A solution to this problem is illustrated in the following FIG. 7.

As in FIG. 6, FIG. 7 shows two points of reference each comprising a horizontal axis showing the time in seconds and a vertical axis showing the current in amps. The illustrated curves 9 and 10 show a new setpoint Id^{ref} and the detailed variation in the current Id in amps passing through the inductive component as a function of this new setpoint, respectively. The illustrated curve 11 shows the variation in the value of the current Id (curve 10) after a running mean.

It appears that, like the setpoint illustrated on the curve 6, the setpoint of the curve 9 takes a first value equal to a mid-threshold of approximately 80 A and a second value equal to a high threshold of approximately 105 A. The setpoint of the curve 9 differs from that of the curve 6 by a third value, called low threshold, that the setpoint takes during the uncontrollability phases. As an exemplary embodiment, the value of the low threshold is 66 A. After having taken this third value, the setpoint of the curve 9 increases again towards the average threshold value first value. As an exemplary embodiment, the duration of increase from the third to the first value is π/4 radians, the reference being the electrical angle cot of the voltage Ve=Vₘ sin(ωt). The corresponding increase duration given in period is therefore ⅛ period, i.e. in the case of a frequency 50 Hz: (π/4)/(2.π.50)=2.5 ms.

With this new setpoint, it appears, on the curve 10, that the current Id still slightly exceeds the setpoint, but with a value that is much less than that of the curve 7. This is due to a slow increase in the current Id from the third value to the first value from the end of an uncontrollability phase, this slow increase being due to the setpoint Id^{ref} which also displays this slow increase.

Subsequently, the current Id illustrated on the curve 10 will reach a maximum value similar to that of the curve 7, then a minimum value that is slightly less than that of the curve 7. More precisely, the current Id of the curve 10 will reach a minimum value of 60.89 A and an average value (illustrated on the curve 11) around 79.86 A, ranging between 79.83 and 79.92 A. The setpoint of the curve 9 therefore allows the average value to be reduced and too sudden an increase to be prevented, this excessively sudden increase causing harmonics on the current and the setpoint to be exceeded.

However, with the setpoint of the curve 9, the obtained minimum value of 60.89 A is not quite enough since it only allows a safety margin of 60.89 A−43 A=17.89 A.

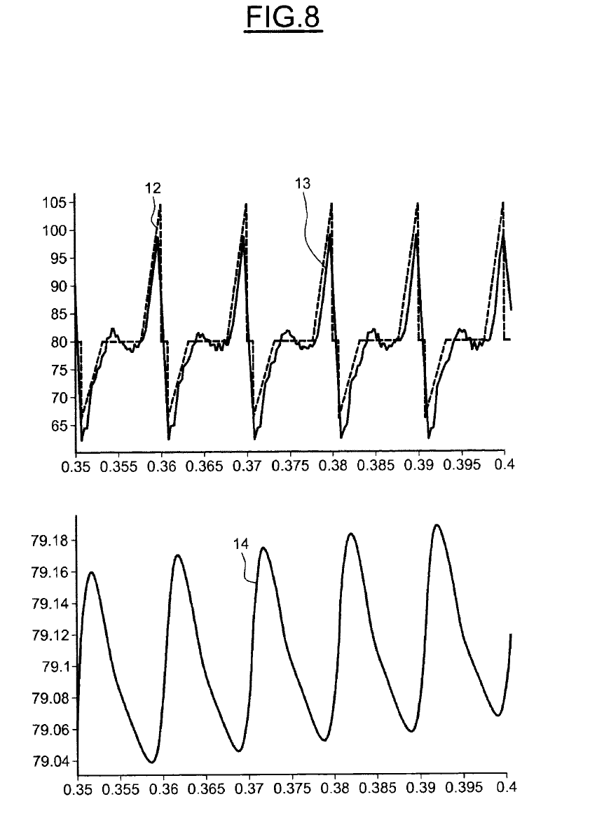

FIG. 8 proposes a setpoint for overcoming this problem. As in FIG. 7, FIG. 8 shows two points of reference each comprising a horizontal axis showing the time in seconds and a vertical axis showing the current in amps. The illustrated curves 12 and 13 show a new setpoint Id^{ref} and the detailed variation in the current Id in amps passing through the inductive component as a function of this new setpoint, respectively. The illustrated curve 14 shows the variation in the value of the current Id (curve 13) after a running mean.

It appears that, like the setpoint of the curve 9, the setpoint of the curve 12 takes a first value equal to a mid-threshold of approximately 80 A and a second value equal to a high threshold of approximately 105 A and a third value equal to a low threshold of approximately 66 A. The setpoint of the curve 12 differs from that of the curve 9 by a plateau assumed by the setpoint during the uncontrollability phases.

This plateau corresponds to a constant value taken by the setpoint induction intensity for a certain duration when moving from the second to the third value. As an exemplary embodiment, the duration for which the constant value is taken is 0.07.π radians, the reference being the electrical angle ωt of the voltage Ve=Vₘ sin(ωt). The corresponding duration expressed in period is, therefore, 0.035 period, i.e. in the case of a frequency 50 Hz: (0.07.π)/(2.π.50)=0.7 ms. As an exemplary embodiment, the constant value taken is the first value, i.e. the mid-threshold which has a value of approximately 80 A.

With this new setpoint, it appears, on the curve 13, that the current Id takes a minimum value (during the uncontrollability phases) that is much greater than that of the curve 10. This is due to the presence of the plateau in the setpoint which, although during an uncontrollability phase, allows the setpoint to be prevented from further decreasing the current passing through the inductive component.

In addition to this point, the shape of the current Id illustrated on the curve 13 is similar to that of the curve 10. The current Id of the curve 13 will, therefore, reach a minimum value of 62.51 A and an average value (illustrated on the curve 114) around 79.1 A, ranging between 79.03 and 79.19 A. The setpoint of the curve 12 therefore allows the minimum value of the current Id to be raised slightly while retaining an average value that is similar or even less (−0.7 A).

The setpoint illustrated in FIG. 12 therefore allows a safety margin of: 62.51−43=19.51 A to be achieved which is sufficient while allowing a decrease in the average value of the current Id of approximately 18% (79.1 A compared to 96.6 A).

FIG. 9 illustrates the comparison of the variables of the recharging system as a function of the setpoint. FIG. 9 shows three points of reference each comprising a horizontal axis showing the time in seconds and a vertical axis showing the current in amps, the voltage in volts, and the current in amps, respectively.

The illustrated curves 15 and 16 show the setpoint induction intensity Id^{ref} according to the curve 12 and the setpoint induction intensity according to a constant value Id^{ref}=100, respectively. The illustrated curve 17 shows the variation in the voltage Ve, as a function of the phases of uncontrollability already illustrated in FIG. 4. Finally, the curves 18 and 19 show the current Id for the setpoint illustrated on the curve 16 and for the setpoint illustrated on the curve 15, respectively.

In FIG. 9, it appears that the variation in the setpoints Id^{ref} of the curves 15 and 16 can be divided into four steps:

A first step during which the setpoint Id^{ref} of the curve 15 takes a constant value equal to the first value. The current Id of the curve 18 can, therefore, be held at a value lower than with the regulation with the setpoint of the curve 16. This gives a duty cycle aₛ which corresponds to a transmission of a larger part of the current Id passing through the inductive component (also called neutral current) to the battery than with the setpoint of the curve 16. Indeed, the average value of the current is closer to the current I_{bat} while remaining greater than it. Therefore, this produces an increase in efficiency.

A second step where the setpoint Id^{ref} of the curve 15 increases towards the second value. The current Id of the curve 18 follows the setpoint and is, therefore, increased in order to anticipate the future loss of controllability (illustrated by the curve 17 which approaches the zero value). The current Id will therefore drop from a higher value, which also allows a higher value to be reached at the end of the drop.

A third step carried out during a uncontrollability phase in the course of which the setpoint drops from the second value to a third value, said drop comprising a plateau in the course of which the setpoint retains a constant value (for example, the first value).

A fourth step in the course of which the setpoint of the curve 15 rises slowly again from the third to the first value.

All of the solutions illustrated in FIGS. 6-9 consist in working out a setpoint Id^{ref} such that it follows a non-constant curve. They are implemented using the module 31 which will work out said setpoint as a function of the current Ie.

1-9. (canceled)

10. A method of controlling charging of a battery, or a battery of a motor vehicle, from a monophase network, the method comprising:
filtering an input voltage;
supplying electrical power of the network to the battery via a buck stage and a boost stage which are coupled together via an inductive component; and
monitoring an intensity of current passing through the inductive component as a function of an intensity setpoint, the intensity not being continuously controllable;
wherein the intensity setpoint is worked out to have at least a first value and at least a second value greater than the first value, the intensity setpoint having the second value before a start of a phase during which the intensity is not controllable.

11. The method as claimed in claim 10, wherein the intensity setpoint is worked out to have a third value, which is less than the first value and second value, the setpoint moving from the second value to the third value during a phase in which the intensity is not controllable.

12. The method as claimed in claim 11, wherein the intensity setpoint is worked out such that, after having had the third value, the setpoint moves from the third value to the first value by following an increasing affine function.

13. The method as claimed in claim 11, wherein the intensity setpoint is worked out such that, when moving from the second value to the third value, the intensity setpoint takes a constant value for a specific duration.

14. The method as claimed in claim 13, wherein the constant value is equal to the first value.

15. The method as claimed in claim 10, wherein an input current of the buck stage is created in phase with an input voltage of the buck stage.

16. The method as claimed in claim 15, wherein the input current of the buck stage is regulated by controlling, in open loop, a chopping duty cycle of the buck stage as a function of a voltage of the monophase supply network, of a setpoint power, and of the intensity of the current passing through the inductive component to phase the input current of the buck stage with the input voltage of the buck stage, and control power received by the battery with respect to the setpoint power.

17. The method as claimed in claim 15, wherein the intensity of the current passing through the battery is regulated with respect to a reference battery intensity by controlling, in closed loop, a chopping duty cycle of the boost stage as a function of a voltage at an output of the buck stage, of a voltage of the battery, and of a difference between the intensity setpoint and the intensity of the current passing through an inductive component.

18. The method as claimed in claim 17, wherein the integral part of a proportional integral controller is deactivated if the chopping duty cycle is equal, within one threshold distance, to values 0 or 1.
